(19) United States
(12) Patent Application Publication
(10) Pub. No.: US 2008/0173825 A1
(43) Pub. Date: Jul. 24, 2008

(54) Particle violation spectroscopy

(76) Inventor: Eric Stanley Reiter, Pacifica, CA (US)

Correspondence Address: Eric Reiter, 251 Nelson, Pacifica, CA, 94044, US

(21) Appl. No.: 12/008,179

(22) Filed: Jan. 9, 2008

Related U.S. Application Data
(60) Provisional application No. 60/879,692, filed on Jan. 10, 2007.

(51) Int. Cl. G01J 1/42

(52) U.S. Cl. 250/393

(57) ABSTRACT

The method shows how to violate predictions of quantum mechanics for matter. For light, the method has been disclosed in patent application Photon Violation Spectroscopy. The methods are different in specifying different methods for light and matter. For matter, the method typically uses the single 5.5 MeV alpha (He++) emitted from the radioisotope Americium-241 in spontaneous decay, a thin gold foil beam splitter, and two surface barrier alpha detectors. The detectors deliver a characteristic electrical pulse with amplitude proportional to matter wave energy. A circuit reads the coincidence rate and singles rates of pulses from the two detectors. Quantum mechanics predicts that the particle would go one way or the other at the beam splitter, and coincident detections of pulses characteristic of such a particle would occur only at an easily calculated chance rate. However, the method at hand shows such characteristic pulses occur in coincidence at a rate greatly exceeding chance. By exceeding chance the method demonstrates surpassing a binding energy threshold and predictions of quantum mechanics. The degree above chance is a new measure in fundamental physics and is usable as a material science probe of the beam splitter. An apparatus specially designed to test for the absence of true coincidences and then perform a beam splitting test to show split-beam coincidences becomes useful in applying the method of Particle Violation Spectroscopy to material science. Fundamental discoveries in physics have been made with this method; therefore it is a method of discovery in physics.

### CROSS-REFERENCE TO RELATED APPLICATIONS

Provisional patent No. 60/879,692 was filed on date Jan. 10, 2007, under the name: Eric S. Reiter, for title of invention: Particle Violation Spectroscopy.

### STATEMENT REGARDING FEDERALLY SPONSORED RESEARCH OR DEVELOPMENT

Not applicable

### REFERENCE TO A MICROFICHE APPENDIX

Not applicable

### TECHNICAL FIELD

This invention relates to the field of physical measurement and more particularly to the field of physical spectroscopy.

### BACKGROUND OF THE INVENTION

My invention is a method of investigating the fundamental nature of matter and energy, and is made possible by discoveries of my own finding. I am claiming intellectual property rights for a method of measurement that prior art physics had improperly tested, and if quantum mechanics was right would result in useless noise. My claims clearly do point out patentable novelty. This patent is about Physics. Inventions are based upon scientific principles called physics. I have made an advancement in physics as evidenced by the data presented in my patent pending Photon Violation Spectroscopy US 2005/0139776 published Jun. 30, 2006. The method at hand of Particle Violation Spectroscopy differs from my previous work Photon Violation Spectroscopy. Photon Violation Spectroscopy describes how to defy quantum mechanical predictions applied to light. Particle Violation Spectroscopy describes how to defy quantum mechanical predictions applied to matter. Particle Violation Spectroscopy and Photon Violation Spectroscopy have the same physics in common, with similar yet distinct methods. The physics behind both of my methods concern a solution in physics to the wave-particle duality paradox.

Well known prior art experiments have revealed wave properties of so-called particle beams. C Davison and L H Germer published “Diffraction of electrons by a crystal of nickel,” (1927) Physical Review, volume 30, No. 6, pages 705 to 740. Within two months G P Thompson published his electron diffraction experiment, as described in J J Thompson's book Recollections and Reflections (1937) page 347. G P Thomson's work is best described in his book The Wave Mechanics of the Free Electron (1930). Molecular wave diffraction was clearly demonstrated in the experiments of I Estermann, R Frisch and O Stern in “Monochromasierung der de Broglie-Wellen von Molekularstrahlen,” Zeitschrif für Physik A (1932) volume 73, pages 348 to 365. In modern physics, these experiments have been described in terms of quantum mechanical particles influenced by a purely mathematical wave function. Physicists know classical particles do not diffract, but they think that quantum mechanical particles somehow do diffract. So-called particle diffraction experiments have always been evidence of a fundamental problem in physics. It is well known to be a problem because prior art has never devised a reasonable way to understand how classical particles can display wave properties. It is well known that the model of classical particles cannot be adjusted in any way to explain wave cancellation or diffraction effects when detection rates are adjusted to one at a time. Furthermore there is no reasonable way to understand how the energy of a wave could spread through macroscopic space, and then somehow collapse to cause a particle-like detection event to take place. This problem, often called a paradox, is known as wave-particle duality. The term “quantum mechanical particle” implies paradoxical wave-particle duality.

Predating wave-particle duality for matter was wave-particle duality for light, originating in Einstein's famous photoelectric effect paper of 1905, “On a Heuristic Point of View Concerning the Production and Transformation of Light.” It is a paradox! I have experimentally resolved the wave-particle duality paradox relating to both light and matter. Experimental evidence for my method of solving the wave-particle duality paradox for light is described in detail, in US patent pending US 2005/0139776 published Jun. 30, 2006. In US 2005/0139776, 1 describe the method and underlying theory as to how the principle of the photon can be overturned. I show with experiment and theory that light spreads classically, and is not held together in anything resembling a particle at all. In US 2005/0139776 I used my loading theory to explain experiments that are famous for being interpreted to show light is particles. The loading theory and the theory of quantum mechanics make opposite predictions in the class of beam splitter experiments related to my method. My theoretical work described in US 2005/0139776 was used by me to predict the experimental results in the disclosure at hand. At the time of my writing US 2005/0139776 on splitting the gamma ray, I did not have experimental evidence to demonstrate that matter likewise could split as a wave to cause detector-event coincidences beyond chance. However, the disclosure at hand includes the necessary evidence to show that the phenomena described by prior art with particles, are best described as thresholds in the loading theory. Both the classical and quantum mechanical understanding of the word particle presume that such a particle would hold itself together as an intact package incident upon a microscopic absorber.

My tests have recorded detector pulses in coincidence, at rates beyond the chance rate predicted by quantum mechanics. My test results are consistent with the theory that a resonant precursor of the nuclear wave function, known as the atomic nucleus, must exist in a partially loaded state. The existence of a partially loaded state raises the probability that an incident pulse of matter-wave energy can fill this partially loaded state to a threshold and trigger multiple detectable absorption events in coincidence. One measure of this threshold is Planck's action constant h used as a maximum. In the loading theory, action at or beyond h, could lose stability and a quantum of energy would be released, but this energy would spread like a wave. The energy released can be either electromagnetic, as tested with the gamma ray in the method of Photon Violation Spectroscopy, or the energy released can be a matter wave, as tested with the alpha ray in the method of Particle Violation Spectroscopy.

In Particle Violation Spectroscopy, the source of matter-waves is radioactive spontaneous decay, but this does not necessarily limit my method to using spontaneous decay. My evidence employs alpha rays, high speed helium nuclear matter-waves emitted in spontaneous nuclear decay. It would be misleading to explain my invention and physics with the usual term “alpha particle.” In mainstream physics, the treatment of conservation of energy is performed with particles emitted, processed, and absorbed, with no account of a pre-loaded state. Mainstream physics commonly assumes that even a quantum mechanical particle is just a shrunken down classical particle that is associated with a guiding wave function, and that the particle makes a crash landing to cause an absorption event. I warn that words like “atom” and “electron” should instead refer to their experimentally associated phenomena and not to tiny spheres that require a paradoxical world.

In loading-theory physics behind Particle Violation Spectroscopy, an aggregate of solid state matter may be faithfully modeled as atomic particles, and we may model standing waves to account for measured spectroscopic atomic structure. However, when an elemental wave function in its particle-like state (such as heliumness) is released to travel across space it loses this particle-like property and must spread longitudinally and transversely as a matter wave to account for interference effects. In the solid state, a stable matter wave may shape space with centers of its mass distribution described by particles, but such a mass can be released to convert its standing wave kinetic energy into a traveling spreading matter wave. The wave has a characteristic that can load up in a standing wave system elsewhere, to load to a threshold that can suddenly be released to give the illusion that a particle hit there.

To my knowledge, prior art physics did consider the loading theory, for light loading into the charge wave (electrons), but did not consider the loading theory for matter (atoms). The loading theory was first introduced in 1911 by Max Planck in his paper “Eine neue Strahlungshypothese,” found in a collection of his works Physikalische Abhandlungen und Vorträge. Here Planck described continuous emission and explosive absorption, and theorized an energy E in the inequality 0<E<hv, where h is his action constant, and v (Greek letter nu, not an italic v) is electromagnetic frequency, and also the same frequency of a material oscillator (the same way I do). In this 1911 paper, Planck used the average energy hv/2 to derive his famous black body heat distribution equation. Planck's inequality algebraically implies action can be any value between 0 and h. The loading theory was described in T Kuhn's Black Body Theory and the Quantum Discontinuity 1894-1912 (1978) as Planck's second theory. The only other works to be found on the loading theory are by P Debye and A Sommerfeld, one of which is “Theorie des Lichtelektrischen Effektes vom Standpunkt des Wirkungsquantums,” Annalen der Physik (1913) volume 346, issue 10, pages 873-930, date. Planck's second theory with continuous absorption in black body radiation was well described in O W Richardson's book, The Electron Theory of Matter (1914) first edition, page 350. The research of E O Lawrence and J W Beams, “The Element of Time in the Photoelectric Effect,” Physical Review 32, page 478 (1928), giving curves of current verses time clearly shows there are minimum, average and maximum times to be considered. Early authors who strongly taught in their books to ignore or make implausible the idea of the pre-loaded state were M Born, Atomic Physics (1935), and Hughes and DuBridge, Photoelectric Phenomena (1932), chapter 2-9, pages 32-33. The loading theory was considered in A H Compton and S K Allison's book X-Rays in Theory and Experiment (1935), page 47, and in R A Millikan's book Electrons (+ and −) (1947), page 253. Compton and Millikan understood the loading theory to the extent that they considered the existence of a pre-loaded state, but did not embrace it. In all publications thereafter, in all my long search for it, writing on any form of loading theory, otherwise known as the accumulation hypotheses, was crippled by confusion over the issue of response time. There is indeed a lag in photoelectric current, as shown by Lawrence and Beams. Often a calculation is made of the loading time that unfairly compares a calculated maxi mum loading time to the experimentally observed minimum response time. The average loading time does change with intensity, but this is not acknowledged when only the minimum time is given to consider. These faulty arguments are the norm in physics and are still taught, most notably in Halliday and Resnick, Physics, sub-chapter on Photoelectric Effect.

I have found several errors of the sort described above and errors in other fundamental cases of historical physics resource. Another significant textbook error, also in cited Halliday and Resnick, sub-chapter The Compton Effect, is the common portrayal that “The presence of a scattered wave of wavelength λ′ cannot be understood if the incident X-rays are an electromagnetic wave.” It is very easy to go to Compton and Allison's book cited page 232 to find an electromagnetic wave explanation, similar to the one described by E Schrödinger, Ann der Phys (1927), 82, page 257.

In the loading theory, the alternative to the concept of the particle is the threshold. Planck's second theory of 1911 introduced a threshold concept of energy: emission is quantized, and absorption is continuous up to a threshold. Prior art experiments, other than my own, have never shown quantized absorption to fail. In prior art physics, continuous absorption was not found necessary because a purely mathematical probability wave adequately described our measured wave properties, so the particle/probability model of quantum mechanics prevailed. After Max Born criticized Schrödinger's wave packet interpretation, as in Born's book Atomic Physics, formal mainstream physics and certainly our textbooks only published the particle/probability model.

The first coincidence experiment sensitive to ray characteristics was by W Bothe and H Geiger, “Uber das Wasen des Comptoneffekts,” Zeitschrift fur Physik (1925) pages 639-663, vol. 32, where an x ray tube was used as a source to interact with hydrogen surrounded by an electron detector and a Geiger counter. Their coincidence rate was 11 times greater than chance, but that is what you would expect from two different kinds of detectors detecting two kinds of “particles.” In contrast to the Bothe Geiger experiment, I use the same kind of detector in both paths coming from the same direction. It is mis-advised to attempt such a test if you think things act like quantum mechanical particles, but it is reasonable to attempt such a thing as a test of the loading theory. It is not obvious to test the loading theory, especially since such a vast amount of prior art literature claims to have already tested and discredited it, and the patent office grants patents on the basis that quantum mechanical theory is true. I have described in Photon Violation Spectroscopy major mistakes that were made in testing the loading theory. The loading theory and quantum mechanics cannot both be upheld without a major revision or replacement of quantum mechanics. I do not know of anyone else currently working with the loading theory, and it is not obvious to do so. The form of experiment that has been repeated to strengthen the argument of quantum mechanics along the issues brought up by the Bothe Geiger experiment has to my knowledge only searched for how close together in time the coincidences have occurred. Prior art experiments of the Bothe and Geiger experiment form have side stepped the deeper issue of a pre-loaded state. Prior art experiments with “particles” have side stepped the deeper issue of a pre-loaded state.

In my knowledge, in all prior art tests of the loading theory, beam splitter tests were employed using only electromagnetic light. Prior art beam splitter tests with light did not give coincident detection rates beyond chance, and that result would make a test to split a matter wave in the view of quantum mechanics a waste of time. The idea behind the beam splitter tests I speak of seemed to originate in a thought experiment of Einstein's, recalled by N Bohr in his book Atomic Physics and Human Knowledge (11958): “If a semi-reflecting mirror is placed in the way of a photon, leaving two possibilities for its direction of propagation, the photon may either be recorded on one, and only one, of two photographic plates situated at great distances in the two directions in question, or else we may, by replacing the plates by mirrors, observe effects exhibiting an interference between the two reflected wave-trains.” It is the first half of this quote/prediction that my experimental results conflict with. This beam splitter test has been performed in prior art using x-rays and visible light, and only chance coincidence rates were found, consistent with quantum mechanics; there was no unquantum effect. By these prior art tests, a physicist would predict that any quantum mechanical particle would behave similar to the photon: it would go one way or another at a beam splitter. I know of no prior art attempt to split what was thought of as a beam of material particles, into two beams of the same particle type, and to search for coincidences of pulse heights that are characteristic of that same particle type, employing a detector in each of the two beams. There are such things as particle telescopes that have similar detectors and electronics to sense coincidences, but they have never been used to test if what they thought was one particle, would become two. The way to think about such a thing is to give up the idea of particle-like absorption, and embrace the loading theory.

An important component of my theory is to make the action constant h, the electronic charge constant e, and the electronic mass constant m, all be maximum thresholds, so that the ratio of any two of these three measures would stay unchanged as a wave thins out in space. Measurements will not show a lower action, charge, or mass because a ratio such as action/mass will be conserved and expressed in our measurements. My earlier patent application Photon Violation Spectroscopy elaborates on the loading theory.

Of course, with matter, and particularly the alpha, there is a binding energy issue that must be addressed. In the case of alpha rays, if a so-called alpha particle has a kinetic energy greater than its own binding energy, the alpha is known to split to display subatomic characteristics. Similarly, if an incident so-called alpha particle has kinetic energy exceeding the binding energy of a target atom, the target can be split into subatomics. See R D Evans' book The Atomic Nucleus, page 299. However, conventional physics will not understand a way for these splittings to occur if the incident kinetic energy is below its binding energy threshold. Therefore conventional physics will predict that a material particle with insufficient kinetic energy to cause a split, will go one way or another at a point of reflection. By prior art physics, such an experiment would predict coincident detection events only at the accidental chance rate. A prior art physicist would predict a low energy particle would go one way or another at a beam splitter; it would not go both ways at once, it would not violate binding energy calculation, and it would not cause coincident detections in two subsequent beams.

In the beam splitter test there must be a way to determine if a single so-called particle is emitted toward the beam splitter one at a time, and that multiple particles are not simultaneously emitted. The test for a singly emitted particle is called a true coincidence test and is well known in physics. A detection application specifying opposed detectors has been patented by Drukier U.S. Pat. No. 5,866,907 to measure true coincidences. The detectors need not be opposed, but just need to be adjacent so the detectors each receive a substantial flux in non-overlapping solid angles of radiation. By non-overlapping solid angles, I mean there was no beam splitter and the radiation under study has been released to travel in different directions. A true coincidence test is designed to see if an explosive quantized emission sends energy in different directions at once. If the energy under test, in one direction, obeys the equation for matter-wave wavelength, h=mVλ, or the equation for electromagnetic frequency, ε=hv, the emission is called a quantum mechanical particle. Two of such quantum mechanical particles simultaneously emitted in different directions will create true coincidences. If a true coincidence is discovered in a candidate source for Particle Violation Spectroscopy it can be used to advantage by devoting a trigger detector to capture energy in a solid angle not used by the solid angle captured by the beam splitter. The pulse from the trigger detector can then add a channel to the coincidence circuit used by detectors past the beam splitter. For simplicity, most of my experiments use sources known to release one single so-called quantum of radiation at a time and are not able to produce true coincidences in a true coincidence test, that is, in a test without a beam splitter.

It is important to point out how prior art experiments, of a different class of experiment from the beam splitter experiment class used in this disclosure, would lead to conclusions in support of the probability-wave interpretation, a conclusion in conflict with the usefulness of my method. There have been many attempts in prior art to confirm the probability-wave interpretation of quantum mechanics. Examples of flawed prior art works, that would seemingly render my claims useless, are experiments that report diffraction effects using molecules as large as carbon-60 “fullerene molecules.” Those “fullerene” experiments were performed in the laboratory of Anton Zeilinger, Universität Wien, Austria, and none of their experiments report fringe shift data from the same apparatus as a function of velocity. Such a comparison would have been very simple for them to do because their apparatus included a rotating wheel velocity selector, but such a fringe shift as a function of velocity has not been reported in any of their published papers. Velocity relates to de Broglie's wave equation h=(mass)(velocity)(wavelength) at the heart of quantum mechanics. A good example of the Austrian team's work is: O Nariz, M Arndt and A Zeilinger, “Quantum interference experiments with large molecules” (2003), American Journal of Physics, American Association of Physics Teachers, vol. 71 pages 319 to 325. Such a comparison of fringe shifts with velocity was indeed performed properly by Estermann, Frisch, and Stern in the reference previously cited on page 362. This 1932 work sets the obvious experimental standard that was not reached by the Austrian team. The theory used by the Austrian team was too complicated and contained many unnecessary assumptions. For these reasons, reports by Zeilinger et-al claiming that large molecules interfere or diffract according to a probabilistic de Broglie wave cannot be held as evidence against the validity of my claims. Another criticism is that there was no discussion of the time sense of particle detection. I and my physics are saying particles do not diffract, and that when dealing with low count rates, only mechanisms involving a load-up can display diffraction. Fullerenes are real particles and will not cancel out or constructively reinforce the way a theoretical quantum mechanical particle would. Quantum mechanics assumes no limit to the size quantum mechanics would apply to any particle. Not only is the probability interpretation wrong, but such an interpretation implies a paradoxical physics that I have found mainstream physics publishers do not encourage anyone to unravel. My claims in Particle Violation Spectroscopy and in Photon Violation Spectroscopy, are two distinct methods of demonstrating that all of modern physics has been in error by accepting probability-waves and particles as the reality of nature.

The method of this disclosure is a means of developing the physics I call unquantum physics, and a means of measuring what I call the unquantum effect. The unquantum effect is a measurement in violation of the quantum mechanical model, and all prior art tests, saying a particle would go one way or another at a beam splitter except by chance; such a measurement must also be consistent with measurements revealing such a particle did not split into sub-particles. Quantum mechanics predicts that coincident detections from a source releasing one quantum at a time would not surpass a calculated chance rate. A commercially viable utility of my method, described in my claims, is a material science spectroscopy applied to gold, carbon, silicon and other materials. Another commercially viable utility of my method is to demonstrate my physics discovery with a commercial apparatus to be sold to school labs.

A low cost version of my claimed apparatus can be produced utilizing americium-241 as a low level alpha ray source, and two semiconductor alpha ray detectors with their output pulses digitized by high speed analog to digital converters feeding memory with an interface to a personal computer. Pulse-amplitude windowing and time coincidence functions can be accomplished in digital signal processing software. For the alpha ray, if the source and detectors were placed close together in a miniature embodiment, a vacuum chamber would not be necessary. Another cost cutting method would eliminate the feature of recording the pulse shapes; then simpler comparators and digital logic could detect coincidences to be fed to a host computer or a simple coincidence counter display.

The detailed description of the apparatus and method of this disclosure apply the actual apparatus used to obtain the data presented here. The drawings and description have been properly simplified, but are more than adequate for a physicist to understand how to readily build and operate the apparatus, and perform the method. Multiple repetition and supporting tests relating to the reality of the experimental effects reported in this disclosure have been performed to insure against artifact, procedural error, and instrumentation error.

### DESCRIPTION OF FIGURES

FIG. 1 describes an embodiment for splitting alpha rays with thin foils.

FIG. 2 is a composite of data using 24 carat gold leaf as a beam splitter of alpha rays.

FIG. 3a is a coincidence histogram for the same experiment as for FIG. 2.

FIG. 3b is a coincidence histogram using 23 carat gold leaf as a beam splitter of alpha rays.

FIG. 3c is a coincidence histogram using a surface barrier detector to both detect and split alpha rays.

FIG. 3d is a coincidence histogram with alpha rays and no beam splitter showing no true coincidences.

FIG. 4 describes the arrangement for splitting alpha rays from a diamond powder coated surface.

FIG. 5 is an annotated screen capture of a computer automated test of a diamond powder coated surface splitting alpha rays.

FIG. 6a is a pulse amplitude histogram from a surface barrier detector receiving alpha rays.

FIG. 6b is a pulse amplitude histogram of alpha rays reflecting from a surface of diamonds.

FIG. 7a describes supporting physics evidence from Photon Violation Spectroscopy.

FIG. 7b is a digital oscilloscope graphic for the experiment of FIG. 7a.

### DESCRIPTION OF PREFERRED EMBODIMENT

The radiation source for all of my matter-wave splitting experiments are 2 mm diameter foil disks plated with one microcurie of americium-241. An atom of Am-241 in spontaneous decay emits a 5.5 MeV alpha and a 66 keV gamma Electron volts, eV, is a particle model energy unit, here relating to kinetic energy. I use this energy unit for relating to prior art measurements and this use is not to be construed as my embracing the particle picture. The alpha is related in physics to the helium nucleus, and has the chemical formula He++.

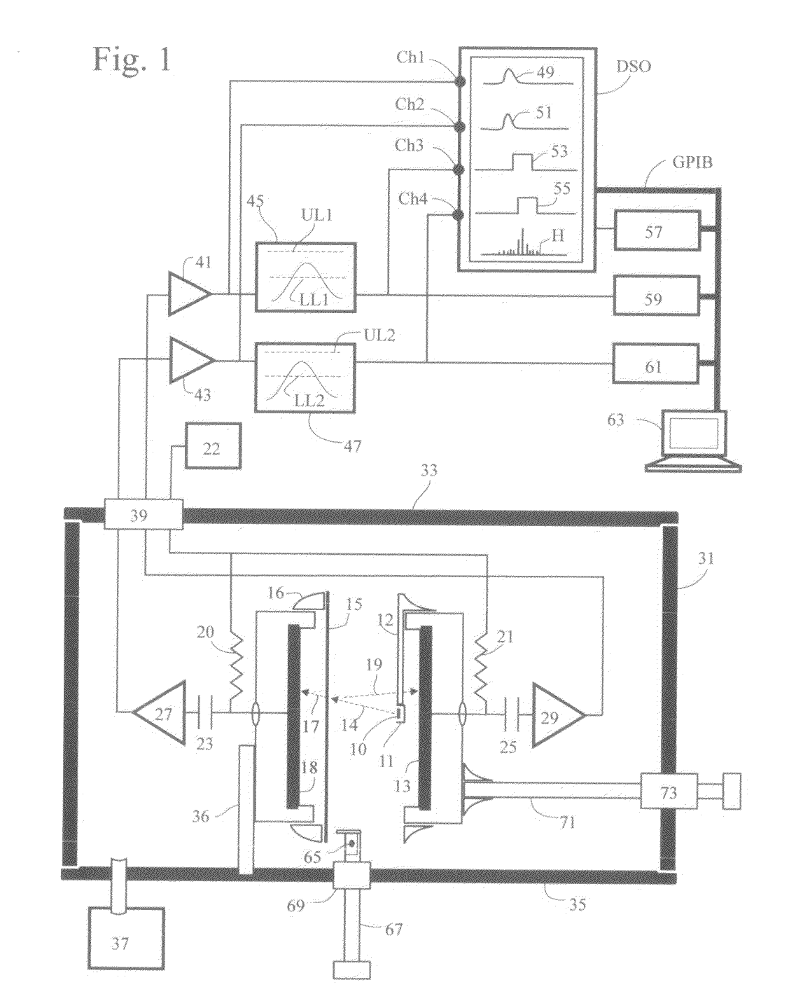

My earliest strong evidence for splitting the alpha ray as a wave was on Apr. 17, 2005 using a gold leaf beam splitter and two ORTEC brand DIAD (discriminating industrial alpha detector) surface barrier detectors, revealing characteristic coincidence detection events at 538 times chance. My disclosed experimental description and evidence use different detectors and a more refined method. Many scattering material types, geometries, and detector types were tested. My most robust evidence employed beam splitter foils of gold and alloys of gold. Commercial surface barrier detectors are constructed two ways: the front surface may be electrically isolated (non-grounded detector surface) from the casing such as those manufactured by CANBERRA, or the front surface may be electrically bonded (grounded detector surface) to the casing such as those manufactured by ORTEC. It was found from careful measurement that the electrically isolated active surface of CANBERRA detectors were vulnerable to cosmic ray interference. Cosmic rays can cause artifact coincidences when two CANBERRA detectors are used. In control tests with the Am-241 source removed, it was found that the one inch (outside diameter) electrically bonded surface barrier detectors from ORTEC were the quietest. A control test was arranged as in FIG. 1 with one of the two detectors being a 1 inch ORTEC, and the second detector a CANBERRA detector. My best control test with all radiation sources removed ran continuously for 3 days, and I measured zero coincidences.

Referring to FIG. 1, Am-241 source 10 is surrounded by cylindrical collimator 11 to prevent alpha rays from directly encountering the surface of reflection detector 13. The source and collimator are typically supported on the outer edges of reflection detector 13 by a thin bar 12 so as to shade the detector 13 as little as possible. A typical alpha ray from spontaneous decay from the source will follow path 14 to encounter beam splitter 15 on mounting ring 16 that fits over transmission detector 18. Beam splitter 15 is typically a thin foil of gold; two layers of artist's 24 carat gold leaf stacked together were found to work best. Most often the alpha ray will continue with most of its kinetic energy intact along typical path 17 toward transmission detector 18, a surface barrier detector. In some cases a component of the initial alpha ray will be reflected along typical path 19 toward reflection detector 13. This reflection from a gold foil is the same phenomenon as observed in the famous experiment of Geiger and Marsden, and whose data was used by Rutherford to show evidence of a particle-like gold atom with a dense nucleus. The effects to be observed in the method of Particle Violation Spectroscopy occur when the alpha ray splits and travels simultaneously along typical paths 17 and 19 to cause simultaneous pulses of current from 13 18 detectors.

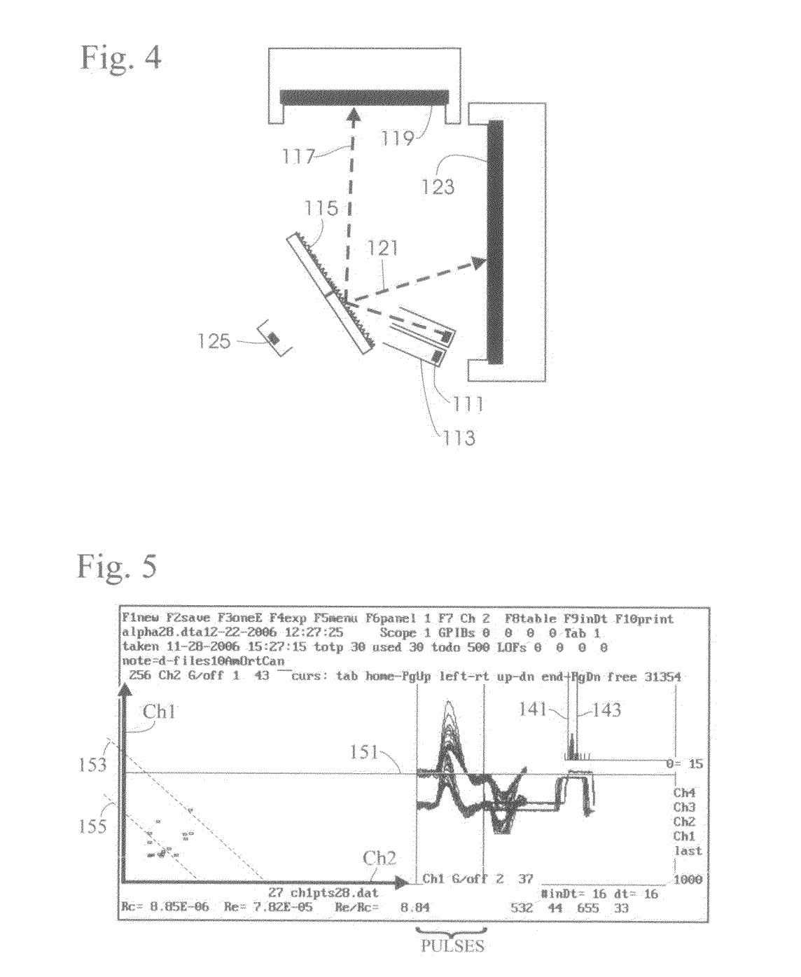

The bias and amplification of detectors 13 18 are performed by conventional methods in nuclear engineering. Briefly, the output terminals of detectors 13 18 are provided with a DC bias voltage via resistors 20 21, typically 10 megaohms, to bias the detectors with negative 40 volts, and are powered by DC power supply 22. The detector's output current pulse is coupled via capacitors 23 25, typically 1 microfarad, to preamplifiers 27 29. The preamplifiers used were Linear Technology LT1222 op amps with a 155 kohm resistor and 1 pf capacitor in parallel (not shown) for the inverting amplifier feedback network, and with the op amp positive input grounded via a 1 kohm resistor (not shown). The detectors and amplifiers are housed in a vacuum chamber constructed from a cylinder 31 with removable end caps 33 35. With detector 18 on support 36, end cap 35 can be rotated to orient detector 18 at different angles employed for reflection studies described in FIG. 4. The chamber is evacuated of air with vacuum pump 37 to a modest vacuum of approximately 100 millitorr. Ultra high vacuum technique is not required for alpha work. I tested the alpha-split effect using both a roughing pump and, at a better vacuum, using a turbomolecular pump, with gages, and found no difference. The bias and detector signal wires connect by feedthrough 39 to the outside of the vacuum chamber. The pre-amplifiers require power wires, not shown, and use additional pins on feedthrough 39.

Amplifiers 41 43 were commercial modules from ORTEC, designed to work with ORTEC single channel analyzer (SCA) modules 45 47, the amplifier/SCA set being specified by ORTEC to minimize timing “walk” errors as a function of pulse amplitude. The amplifiers used were ORTEC model 460 and the SCA modules were ORTEC model 551. Although there are many ways to set up a coincidence circuit, the easiest and most convincing method is to use a full featured digital storage oscilloscope DSO. My data was obtained using a LECROY model LT344 DSO. Instruments of this class contain high speed analog to digital conversion electronics and digital signal processing features for obtaining coincidence histograms. Channels 1 and 2 of DSO, Ch1 Ch2, monitors the output of amplifiers 41 43. Channels 3 and 4 of DSO, Ch3 Ch4, monitor the square wave timing pulse output of SCAs 45 47. Ch1 Ch2 are useful for seeing that pulses 49 51 are not misshapen due to noise or pulse overlap. Ch3 Ch4 are used by the LT344 smart trigger mode that triggers when SCA pulses 53 55 are within a preset time from each other, in most experiments within 100 nanoseconds; this is the coincidence circuit. The lower level settings LL1 LL2 of the SCAs must be set high enough to eliminate noise; here I set these levels to ⅓ of the characteristic pulse amplitude of the 5.5 MeV alpha ray. The SCA upper levels UL1 UL2 were set to its maximum in my alpha experiments. The range of pulse amplitudes between LL1 and UL1 is window number 1, and the range of pulse amplitudes between LL2 and UL2 is window number 2. The time between Ch3 Ch4 timing pulses is plotted in coincidence histogram H by the DSO. A time delay feature in the SCA is used to make the channel 1 pulse record first so that histogram H is symmetrical. Coincidence histogram H is the most important output of the experiment. Quantum mechanics would predict a Poisson distribution with an imperceptible slope, essentially a flat band of noise like that of FIG. 3d. Any peak in this distribution indicates there is a mechanism other than noise to be analyzed. DSO outputs a trigger pulse wired to counter 57 to count coincidences. Counters 59 61 count timing pulses from the outputs of the SCAs. The time duration of the experiment is obtained from the DSO or a separate timer (not shown). The time duration and data from the counters provide for a calculation of singles rates from each detector. An enhancement to the data acquisition was employed in some of my tests employing computer 63 connected to DSO, and counters 57 59 61 through bus GPIB; GPIB is a popular instrument communication system. Computer 63 is optional for collecting evidence above chance, but was found necessary in some of my experiments to obtain ordered pairs of pulse amplitude data. Future implementations of my method will likely employ a two channel high speed analog to digital converter with dual port ram interfaced to a host computer to digitize pulse shapes from each preamplifier 27 29, and will perform windowing and coincidence operations in software.

Additional features of the apparatus are required for calibration or various studies. Test source 65 mounted on rod 67 can be manipulated through linear-rotary seal 69 to illuminate each detector with alpha rays, or to illuminate both detectors simultaneously. Detector 13 is mounted on rod 71 supported by linear seal 73 so the optimum spacing between the two facing detectors 18 13 can be adjusted. A spacing of 4 mm between source 10 and gold foil beam splitter 15 was found to be optimal in my tests.

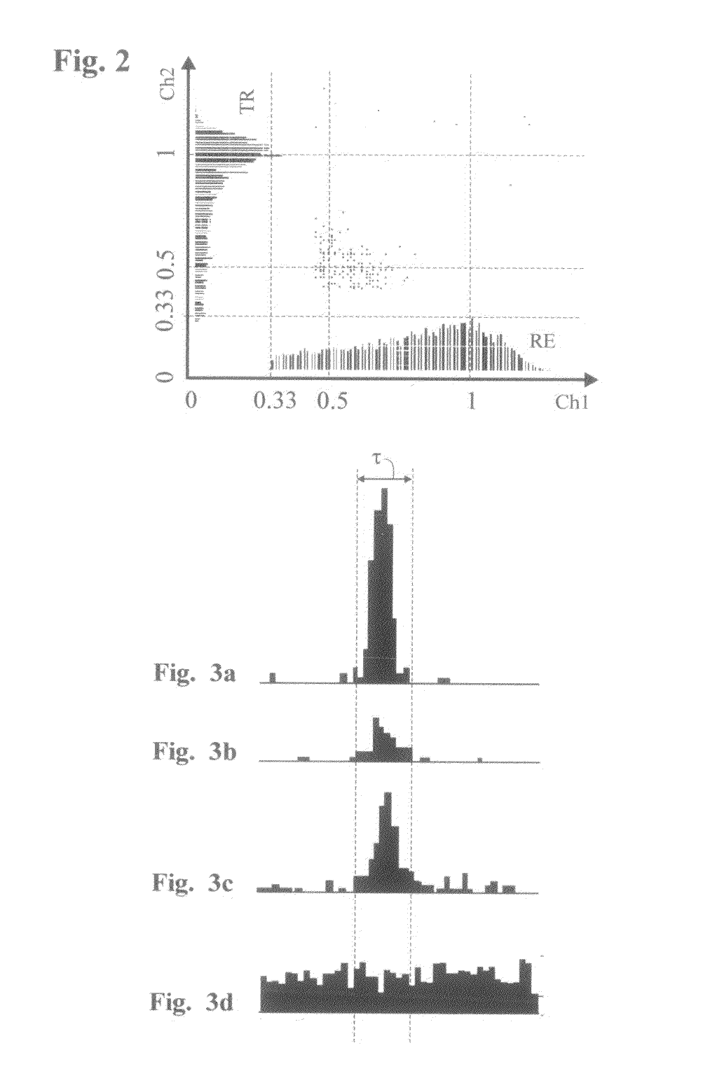

In a pulse amplitude histogram, for example FIG. 2 RE for the alpha ray, a characteristic pulse amplitude is revealed as a peak in the histogram at 5.5 MeV. The alpha can cause pulses over a wide amplitude range. It is known from nuclear physics books and my own tests that an Am-241 source only emits one alpha in an atomic spontaneous decay, and that this source does not cause detector pulses in a surface barrier detector from anything but the alpha ray. The pulse amplitudes are known to be smeared over the histogram by two dominant mechanisms: there are different velocity alphas produced in escaping the solid of the source, and the detector can distort the pulse amplitude. The SCA window for each detector was set to include a wide range of pulse amplitudes, the smallest being ⅓ of its 5.5 MeV characteristic, set by LL1 and LL2, and ranging to an upper limit set beyond what the monitoring oscilloscope DSO was able to acquire without clipping.

FIG. 2 is data from an experiment performed Nov. 13, 2006 that used essentially the same hardware as described in FIG. 1. The data of FIG. 2 is from FIG. 1 coincidence histogram H. The source was one Am-241 disk 10 which emits approximately 1 microcurie of alpha rays. The surfaces of the two surface barrier detectors 13 18 were approximately 9 mm apart from each other, and the detector's working diameter was approximately 2 cm. The beam splitter consisted of two layers of 24 carat gold leaf imported from Thailand and held to aluminum ring 16 with a thin layer of vacuum grease. The histograms of FIG. 2 labeled RE and TR are the reflected and transmitted singles spectra respectively. Data of RE TR was collected with the gold in place and no coincidence gating applied. Pulse amplitude histograms RE TR were collected by a feature in the LT344 DSO. The reflected pulse amplitude histogram IRE was taken using test source 65 pushed up and swung in place to aim at detector 13. The positioning and scaling of the FIG. 2 composite was determined from test pulses and by noting the voltages on DSO. The peak of each RE TR histogram is assumed to correspond to 5.5 MeV and is designated 1 on pulse amplitude scales Ch1 Ch2 of FIG. 2. Position 0.33 for each pulse amplitude histogram was determined by SCA settings LL1 and LL2. The points in the Ch1 Ch2 plane are from coincidences within τ=100 ns as measured from detector pulses 49 51, digitized by DSO, and transmitted to computer 63 for analysis and plotting.

This Ch1 Ch2 way of plotting was accomplished by interfacing between DSO and host computer 63 running a QUICKBASIC program of my own development. It was necessary to develop this xy plot of pulse pairs to see the pair relationships for testing if particle-energy conservation was broken. It is easy to visualize from FIG. 2 that the average pulse pairs occur at about half the 5.5 MeV point. This is what would be expected if an alpha particle were to split into particles, each of half its initial kinetic energy. However in R D Evans' book he clearly describes that it takes over 7 MeV to split a helium nucleus, and even more to split off a component of gold. The kinetic energy spectrum of Am-241 is published in Radiation Detection and Measurement by Knoll page 398 first edition, and shows the maximum initial kinetic energy at 5.545 MeV. Therefore, there is not enough kinetic energy to split the alpha by conventional theory. The detectors and count rates are responding to alpha waves. My method of reading windowed characteristic pulses in coincidence, to see what was thought to be a material particle splitting like a wave, has never been accomplished in prior art.

It is important to understand that the coincidence xy points plotted in FIG. 2 do not occur below about 0.45 of the characteristic average pulse amplitude. This was not due to the SCA settings which were set at 0.33, it is due to the phenomenon. If there were some phenomenon at play other than what I describe, smaller pulse amplitude pairs would be detected in coincidence.

Before performing any of these beam splitter tests, an investigator would perform a simpler test using the same detectors, but with no beam splitter. The detectors would be placed opposing or aside each other with the source radiating in all directions with its radiation to be received roughly equal between the two detectors. These detectors would receive non-overlapping solid angles of radiation. Coincident detections in this non-overlapping detector geometry would be measuring what are called true coincidences. True coincidences are about rays being emitted in different directions from the same radioactive decay producing two particles. After finding in a non-overlapped solid angle coincidence test that there are no true coincidences, it would be thought by any prior art physicist to be utterly useless to attempt to split a “particle” this way; no one has done it. My method shows we are not dealing with particles at all. Matter splits like a wave. To set up a source and detector apparatus to test what looks like by all prior art to be a particle, and then to test for a splitting effect like a wave would not be an obvious method to think of, and if it was thought of it would be useless until found useful in experiment. Finding how to make this test sequence useful and then applying it to gold and diamond analysis is what makes this method an invention.

The experiment of FIG. 2 of Nov. 13, 2006 had a reflected singles rate Rᵣₑ=0.042/sec from the 24 carat gold and a transmitted singles rate Rₜᵣ=2314/sec through the gold. For each coincidence histogram in FIG. 3 the window of times between plotted coincidences was set at τ=100 ns. The chance rate of coincidences is calculated R_{c}=RᵣₑRₜᵣτ=(0.042)(2314)(100 ns)=9.8×10⁻⁶/sec. The experimentally measured rate was Rₑ=(159 coincidences)/(154 ks)=1.04×10⁻³/sec, making the ratio Rₑ/R_{c}=105 times chance. Any ratio greater than 1 and surpassing error margins is significant, because quantum mechanics would only predict a ratio of Rₑ/R_{c} equal to unity. Any prior art would predict the chance rate in such a beam splitter experiment. I am the only person, as of this writing, to break chance for any form of singly emitted quantum in a beam splitter experiment.

A time difference (Δdly) coincidence histogram for the experiment of FIG. 2 is plotted at FIG. 3a by means of the LT344 DSO Δdly histogram and smart qualified trigger features, depicted in FIG. 1H.

From an earlier experiment of Nov. 10, 2006 comes the Δdly histogram of FIG. 3b. Everything except for the beam splitter material was kept unchanged for a good comparison to the experiment of Nov. 13, 2006. Beam splitter 15 was two layers of an Italian brand of 23 carat gold leaf. The transmitted singles rate here was Rₜᵣ=2434/sec, nearly identical to the test of November 13. Singles rates are calculated by the total singles counts per experiment duration, 895 minutes. The similar transmitted singles rates indicate the gold leaves were very similar in their ability to attenuate alpha, indicating the thickness by the stopping power of the 23 carat gold of FIG. 3b was similar to the 24 carat gold of FIG. 3a. The reflected singles rate was markedly different at Rᵣₑ=0.0793/sec. Nearly twice as often alphas were reflected from this less pure 23 carat gold. One might expect the alpha split effect to work better with the 23 carat gold given these singles rates. The chance rate was R_{c}=(0.0793)(2434)(100 ns)=1.95×10⁻⁵/sec and Rₑ=(40 coincidences)/(53.7 ks)=7.45×10⁻⁴/sec, Rₑ/R_{c}=38 times chance, 2.7 times worse than with the 24 carat gold, defying expectation. The 1/24 difference in gold purity could not account for this. The ratio above chance is therefore an interesting measure indicating something extra-nuclear in the metallurgy of the 24 carat gold that could not be measured by prior art alpha interaction physics.

Gold is not necessary as a beam splitter. FIG. 3c shows a Δdly histogram using only the transmission detector surface itself as a beam splitter. This experiment of Nov. 8, 2006 used the same SCA settings and detectors, but with a stronger Am-241 source than in the previously described experiments. There were 10 disks of Am-241: 9 at the periphery of the reflection detector, and one suspended at the center. The strength of the source only changes the length of time to obtain a Δdly histogram that bears a shape discernible from randomness, if such a shape is to be found. It has been found that the strength of the source does not affect the degree above chance. The experimental duration was 6.64 hours, Rᵣₑ=0.15/sec, Rₜᵣ=8527/sec, R_{c}=4.8×10⁻⁴/sec, Rₑ=0.0044/sec, Rₑ/R_{c}=9.3 times chance. The detector surface has a thin layer of aluminum vacuum deposited over silicon, designed for the alpha ray to pass through. It is well known that the silicon wafer itself can be made thin enough for alphas to pass through, and I myself have measured alpha transmission through a thin surface barrier detector. In this case the detector is the material under study. Copper leaf as a beam splitter material under study also revealed a small positive unquantum effect, but tests with palladium and silver leaf foils, plastic, and mica did not surpass chance coincidence. The method of Particle Violation Spectroscopy will undoubtedly be useful in measuring properties of atomic structure of silicon and other materials in the semiconductor industry. The fact that not any beam splitter material is capable of revealing an unquantum effect is evidence of its material specificity. The tests mentioned with palladium and silver leaf foils produced a coincidence histogram of noise resembling FIG. 3d. Gasses were also tested as a beam splitter in March of 2005 using butane (2.3×chance), propane (chance), and oxygen (chance).

Many control tests were performed. A test for true coincidences (simultaneously emitted quanta) of Dec. 7, 2006, shown in FIG. 3d, was performed for 2 hours with a single Am-241 source disk present, using detectors at right angles to each other with no beam splitter so that the detectors received non-overlapping solid angles of radiation from the relatively small pointlike source. The SCA window settings were the same for all the experiments of FIG. 2 and FIG. 3. If there were true coincidences there would be a peak within section T of FIG. 3, the center of which is 0 ns between timing pulses. However, the relatively flat coincidence histogram shows my Am-241 source disk contained no impurity source of true coincidences. The detectors, window SCA settings, and detector positioning within the vacuum chamber for the non beam splitter (true coincidence) control test, were also the same as used for testing reflection of alpha rays on diamonds described for FIG. 4. This true coincidence control test is described in my claims to be performed first. However, it does not matter if this control test is performed first or last, it is only necessary to establish one way or another that the same source, to be used in a separate beam splitter test, does not emit true coincidences. Equivalent to performing this test would be to read published data describing emitted energies in nuclear decay, and to understand that the published data proves the chemically known source is not able to create true coincidences. The true coincidence test applies for both matter and energy rays.

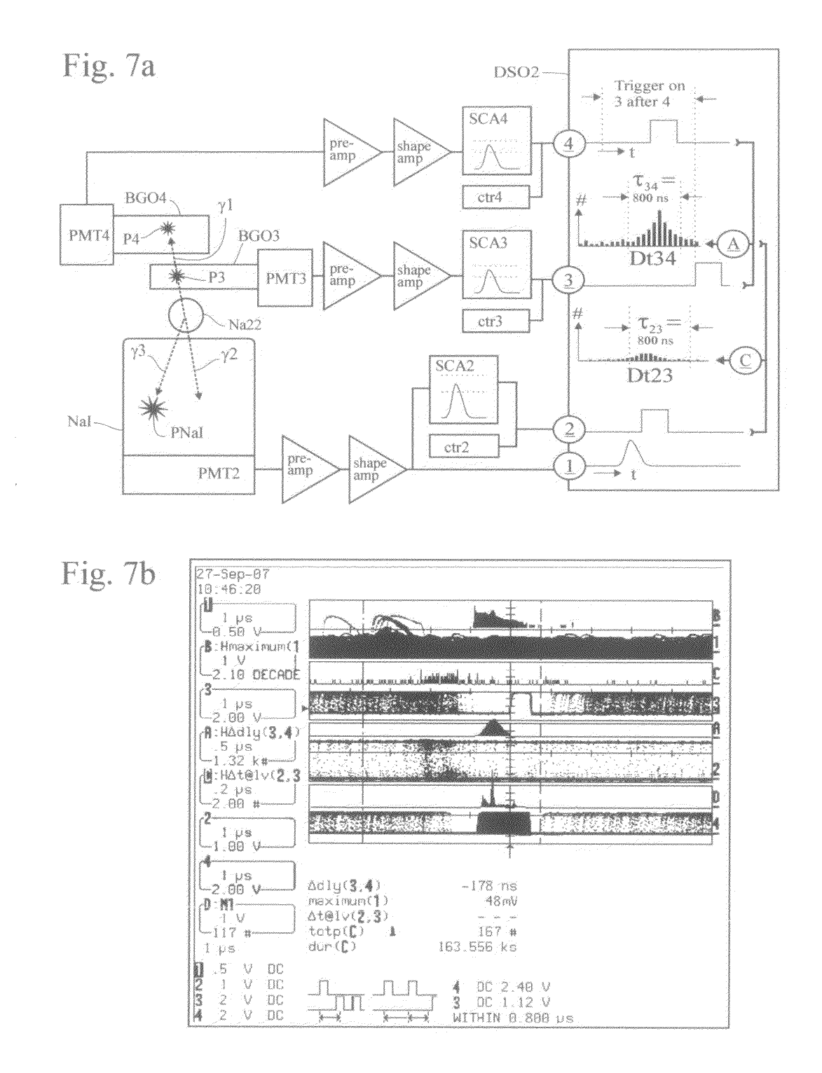

It is still valid to perform my method using a source that does produce true coincidences, if a third detector is placed outside the beam heading for the beam splitter and to use the pulse from this third detector in triple coincidence with the pair of detectors placed past the beam splitter. Detection schemes employing greater numbers of detectors or arrays of detectors are obvious, so long as a set of coincident detections are utilized to defy quantum mechanical chance prediction. A photon violating triple coincidence test is described for FIG. 7, and the pulse analysis aspects of this design are easily adapted to particle violation.

A no-source background coincidence test was performed for 48 hours with everything else unchanged, to accompany the experiments testing the diamond-split effect of FIG. 4. This background test used a 1 inch case diameter ORTEC and a 1.5 inch case diameter CANBERRA PIPS detector at right angles to each other with an Am-241 disk centrally located. This kind of background test was repeated several times with different geometries. In none of these background tests was a single coincidence found, even by chance. This indicates that cosmic rays were not interfering with the experiments. Cosmic rays were indeed found to interfere and cause coincidences when two CANBERRA PIPS detectors were employed, and coincidences occurred at an average rate of about 3/day, with the amplitudes of pulses being irregular. The fully shielded ORTEC detector was therefore shown to protect the measurement from generating artifact coincidences of cosmic origin.

FIG. 4 describes the arrangement used for splitting alpha rays from diamonds. I suspected an unquantum effect with diamond because a resonant reflection of alpha rays at 5.5 MeV was found by Ferguson and Walker, “The Scattering of Alpha-Particles by Carbon and Oxygen,” Physical Review (1940), vol. 58, page 666. In this resonant reflection helium (alpha) joins carbon to make oxygen in an unstable form that quickly decays to return the helium in a retro reflection. It was fortunate that Am-241 ejects an alpha ray at just the right kinetic energy to stimulate this resonant reaction. Ferguson and Walker found that the alpha retro-reflects from carbon at a greater rate than calculated by Rutherford's method; this inspired me to experiment with diamonds as a beam splitter to see if different orders of reflected components of the alpha ray could be detected in coincidence. The experiment of FIG. 4 of Nov. 28, 2006 used 10 Am-241 alpha ray source disks III in two rows of 5, mounted in collimator tubes 113, to aim alpha rays 114 toward a set of diamond powder coated files 115. Beam splitter 115 is a 1 inch square surface of a commercial diamond machinist's file. Alpha rays that were predominantly specular reflected 117 were captured by a 1 inch ORTEC surface barrier detector 119, and alpha rays predominantly retro reflected 121 were captured by a 1.5 inch CANBERRA PIPS surface barrier detector 123. I discovered that to make the effect work, a low level alpha ray ambient source 125 of Am-241 was needed to leak a low level to both detectors without reflecting from the diamonds. Shutter 126 adjusts the flux of matter wave. I assume this is necessary to enhance the pre-loaded state of resonant atomic He++domains in the detector; but I'm not sure. The unquantum effect in this diamond reflection test was found to disappear without source 125, and ambient source 125 alone does not cause coincidences. No correction in calculation need take place because the singles rate measurements read the flux from diamond reflection and from ambient source 125. The duration of the experiment was 6.56 days. The singles rates were calculated in computer 63 by taking the singles counts and time duration between each coincidence event, and then averaging them all.

Experimental results of Nov. 28, 2006 are from the arrangement of FIG. 4 and are shown in FIG. 5, which is an annotated screen capture of the QUICKBASIC program I wrote for automating the experiment and obtaining pulse pair information. There is nothing in my QUICKBASIC program that could not be reproduced from the information in the disclosure at hand by a programmer skilled in BASIC and GPIB interfacing; The appendix CD is the QUICKBASIC program titled alpha19.txt. The chance rate R_{c}, experimental coincidence rate Rₑ, and degree above chance Rₑ/R_{c}=8.84, are displayed at the bottom of FIG. 5, and are calculated using only the valid pulse pairs that were within 160 ns of each other, as set in the program by adjustable vertical line cursors 141 143. There are 16 pulse pairs bracketed in the 160 ns window. The analog shapes of these chosen pulse pairs PULSES are in the computer display. It is readily seen that PULSES are all undistorted, and in coincidence. On the same time scale and to the right of the analog PULSES are timing pulses number 1 and timing pulses number 2 from SCA 45 and SCA 47 respectively. The timing pulses are digitized in DSO in FIG. 1 as 53 55, and re-displayed in computer 63. These timing pulses are 500 ns wide, and their vertical offset in FIG. 5 is artificial. Analog and digital pulses that were from pulse pairs beyond cursors 141 143 were eliminated from the calculation and display. A base line 151 of the analog pulse for one channel is positioned at the keyboard, and is done similarly for the other channel, not shown. These base lines determine the zero of the Ch1 Ch2 coordinate system. The software creating the FIG. 5 display is the same software used for the Ch1 Ch2 plot in the FIG. 2 composite. There were 16 pulse pairs plotted in FIG. 5. The spectacular discovery from this test is that the pulses were big. Diagonal line 153 was calibrated from separate tests and inserted in FIG. 5; this is the line upon which two pulses would add to twice the characteristic 5.5 MeV alpha ray. If a point were plotted on the center of this line it would be from pulses that each had the full characteristic pulse amplitude of 5.5 MeV, as described for FIG. 2. Such a point on line 153 would have broken particle-energy conservation by a factor of 2; only one such point is displayed here. Breaking particle-energy conservation is not breaking the law of energy conservation, it breaks the particle model. I uphold energy conservation. Line 155 is where particle-energy is conserved; a point plotted on the center of this line would be from two (5.5 MeV)/2 detector pulses. Points to the right of line 155 break what I call particle-energy conservation. This is different from energy conservation in general. It shows violation of the principle of the particle, the same way I have shown breaking particle energy conservation in Photon Violation Spectroscopy. Particle Violation Spectroscopy reveals this two-for-one effect, and it is a reasonable prediction of the loading theory.

I performed several tests with the apparatus and method describing FIG. 4, but substituted for beam splitter 115 surfaces of graphite, quartz, gold, and cubic zirconium. None of these beam splitter materials revealed an unquantum beam split effect in this geometry. The fact that the unquantum effect was revealed analyzing carbon in the diamond chemical state but not in the graphite chemical state, is evidence that the method of Particle Violation Spectroscopy is sensitive to the chemical state of the beam splitter, at least for carbon. There are several forms of well developed alpha spectroscopy employed for material analysis, but their mechanism of action is fundamentally different in that they do not use two detectors measuring the same alpha ray in coincidence.

There is yet another mode of particle violation spectroscopy that I have discovered. My earliest success with finding an unquantum splitting the alpha with diamond were obtained as early as Oct. 12, 2005, and those tests did not require a second source, a tickler field so to speak. The test of November 28 did require a field. In a 6.6 ksec test with two Am-241 disks and two jewel diamonds, with singles rates of 1/155 sec and 1/76/sec there were 5 coincident detections within 75 ns and no others, to give Rₑ/R_{c}=6 million times chance. This test used two of the shielded DIAD ORTEC detectors found to be immune to cosmic caused coincident events. The function of the tickler field must have been expressed by an unknown ambient source of the chamber's metal. The chamber was built from parts from a discarded coating machine from Stanford University, and was undoubtedly contaminated. However, control tests in the Stanford machine revealed no background coincident detections that would have confounded the measurement. The data of FIGS. 2, 3, 5, 6, and 7 were not obtained from the Stanford machine. It is an important discovery in itself that the unquantum effect can be modulated by an ambient or a controlled source, as verified by the data of FIG. 5. My alpha ray unquantum effect was tested in three different vacuum chambers. My series of tests also employed different detectors and amplifiers as well. Tests searching for electronic cross talk were also carefully undertaken. It took me two years of rebuilding and testing to convince me the alpha split effects for diamond and gold were real and were in contradiction to prior art particle physics. Prior art physics does not recognize the pre-loaded state in this context. Therefore the discovery of an ambient field modulating the unquantum effect from the data of FIG. 5 is additional evidence of a pre-loaded state.

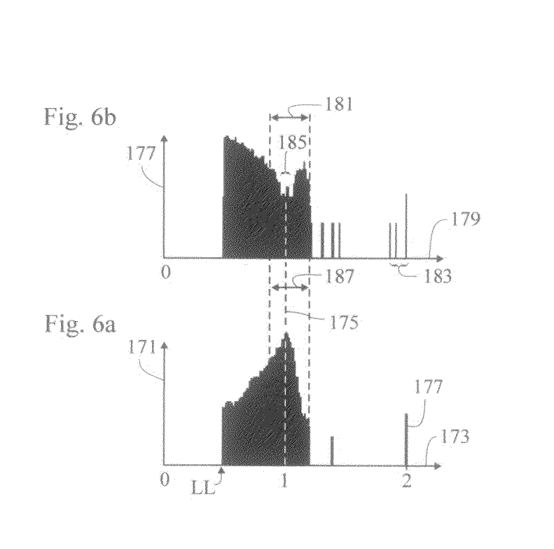

FIG. 6a is a conventional pulse amplitude spectrum of alphas aimed straight toward a single ORTEC detector, of 2 cm diameter active surface. The source was ten Am-241 disks (1 microcurie per disk) mounted in brass collimator tubes similar to 114 of FIG. 4. Vertical scale 171 is logarithmic and horizontal scale 173 is pulse amplitude with one unit marked at the characteristic pulse amplitude and 2 units marked at the expected sum-peak position. The lower level LL cut-off in these histograms is from the SCA setting. A characteristic peak section 187 had a detection rate of 23.3 k/253 sec=92 pulses/sec. From observing the analog pulses on the DSO, an estimate can be made of the time that two pulses would need to overlap to create a sum-peak, and this estimate was made to err in favor of quantum mechanics. This estimate is τs=200 ns. Sum-peak 177 has 2 pulses/253 sec=1/126 sec. Calculation of the expected chance rate for the sum-peak region would be R_{c}=(92/sec)²(200 ns)=1/589 sec. The ratio Rₑ/R_{c} is approximately 4, which for such a low count rate in the sum peak can be taken as a good match between theory and experiment for what is expected for sum peak 177. We see chance, as expected.

FIG. 6b is a pulse amplitude spectrum of alphas now reflecting from a set of diamonds. These diamonds were a pair of diamond earrings and a mosaic of 1 mm triangular diamond macles that added up to a surface of approximately 1 cm². The detector was the same as used for FIG. 6a. The alpha source and detector were both placed approximately 45 degrees above the diamond reflecting surface. Vertical scale 177 and horizontal scale 179 are the same as for FIG. 6a. The range of pulse heights 181 was the same as used for FIG. 6a and had 668 pulses/41 ksec 1.63×10⁻²/sec=R₁. Region 183 on scale 179 at 2 times the characteristic, had 8 pulses/41 ksec=195×10⁻⁶/sec=Rₑ. The chance rate R_{c} for this region would be R_{c}=R₁²τₛ=5.3×10⁻¹¹/sec. Rₑ/R_{c}=3.6 million times chance, reflected from the diamonds indicating a substantially enhanced sum-peak. This is strong evidence for an unquantum effect enhanced by reflecting alphas from diamonds as measured with a single detector. The unusual dip 185 in reflected spectrum 179 implies that a large fraction of the alpha matter wave was not reflected in any omnidirectional sense, but instead implies that a large fraction was either retro-reflected or sent in two directions at once, and was not picked up by the single detector because the source/detector arrangement was not adjusted to receive retro-reflection. Dip 185 sits exactly in the center of the 5.5 MeV characteristic peak 187 of the non-reflected spectrum of FIG. 6a. Here we see consistency between the two-detector beam split test of FIG. 5 and the single detector reflection test of FIG. 6b, which both used diamonds and broke chance. Either the released alpha waves from the diamond reaction were more coherent so as to more readily trigger detection, or energy was released from the diamond; either case is an unquantum effect. I conclude that these alpha diamond unquantum effects are enhanced by the 5.5 MeV alpha resonance with carbon discovered by Ferguson and Walker. Coincidence data of FIG. 5 are due to a retro reflection of the single alpha ray from diamond that took place simultaneously with an omnidirectional reflection of the same single alpha ray. Such a simultaneous splitting of the alpha ray has never been reported in prior art and is clear evidence of the usefulness of Particle Violation Spectroscopy.

Recent Support from Photon Violation Spectroscopy

Useful results from the method of Photon Violation Spectroscopy are additional evidence for the importance and usefulness of Particle Violation Spectroscopy. The physics behind the method of Photon Violation Spectroscopy must be valid for the method of Particle Violation Spectroscopy to be valid. Newly tested evidence refuting the photon model, similar to my evidence given in US 2005/0139776, is emphasized here to show due diligence in developing the physics underlying both Particle Violation Spectroscopy and Photon Violation Spectroscopy. I have discovered in September 2007 that annihilation radiation, a well studied form of gamma radiation from the meeting of an electron and positron, produces a notably strong unquantum effect. When using three detectors, the third to remove a possible artifact produced by a third gamma ray produced in true coincidence, the coincident detection rate approaches 1000 times the rate predicted by chance and quantum mechanics. The third detector acts as a trigger to split the single annihilation radiation gamma.

Referring to FIG. 7a, source Na22 of gamma rays are sodium-22 (Na-22) atoms in spontaneous decay. Na-22 can suddenly emit the smallest unit of positive charge, an anti-electron, in a ray that meets with an ambient negative electron. The charge waves cancel, and two oppositely directed gamma rays γ1 and γ2 are produced. A higher frequency gamma ray γ3 is also produced in the radioisotope decay. Sodium iodide scintillator crystal NaI, is incorporated to respond to gamma ray γ3. Labels γ1 γ2 γ3 are theoretical rays gleaned from many experiments with this radiation from Na-22, and a typical set of rays are shown. The gamma detectors are scintillator crystals that emit a classical pulse of visible light energy proportional to a captured gamma ray's electromagnetic frequency. Detector NaI responds with typical scintillator pulse PNaI. Two bismuth germinate scintillator crystals BGO1 BGO2 are incorporated to respond to γ1. Detector BGO3 responds with typical scintillator pulse P3, and detector BGO4 responds with typical scintillator pulse P4. The scintillator light is converted to an electrical pulse by photomultiplier tubes PMT2 PMT3 PMT4. The single channel analyzer circuits SCA2 SCA3 SCA4 filter electrical pulse amplitudes that are characteristic of the scintillation-captured gamma ray, and generate timing pulses delivered to counters ctr2 ctr3 ctr4 and digital oscilloscope DSO2 channels 2 3 4. The time interval between timing pulses is measured and plotted in typical histograms Dt23, Dt34, the real data of which are plotted in FIG. 7b. Any peak in these histograms indicates coincident gamma ray events surpassing what can be caused by chance overlap; this is the unquantum effect. The signals from SCA2 SCA3 SCA4 are used in triple coincidence to remove any possible artifact. The rate of overlapping pulses 2 3 4, after subtracting a background coincidence rate, was measured at coincidence histogram Dt23 to be a rate 963 times the chance rate, from my experiment of Sep. 27, 2007. For the BGO3 BGO4 pair, the rate of overlapping pulses 3 4, after subtracting a background coincidence rate, was measured at coincidence histogram Dt34 to be a rate 29 times the chance rate, from my experiment of Sep. 27, 2007. The chance equation used was R_{c}=R₂R₃R₄τ₂₃τ₂₄. Mechanism DC of producing the double coincidence histogram Dt34 was the smart trigger feature in the LT344 scope. Mechanism TC of producing the triple coincidence histogram Dt23 was accomplished in the LT344 using its Δdly parameter feature. FIG. 7b is a screen capture of the LT344, graphing the most convincing picture on Sep. 27, 2007. The counter rates were calculated at ctr2=60/sec for the NaI, ctr3=193/sec for the first BGO, and ctr4=129/sec for the second BGO, respectively. The background coincidence rate was 2.075×10⁻⁵/sec. Channel B is the first BGO spectrum vertical logarithmic, and channel D is the NaI spectrum vertical linear, with different pre-amplifier gains. Channel A is Dt34 and channel C is Dt23.

In another similar test of Aug. 23, 2007, using the same BGO3 BGO4 detectors and electronics, Cs-137 with its single gamma ray, is used as a source. The Cs-137 660 keV gamma ray is close in frequency to that of 551 keV annihilation radiation, but no coincidences were detected beyond chance, in a 1.6 hour test. In yet another similar test of Aug. 29, 2007, Mn-54 with its single gamma ray, is used as a source. The Mn-54 700 keV gamma ray gave 3.75 times chance in a test spanning 1.9 days and a background test spanning 25 hours. The data from tests with Cs-137 and Mn-54 as compared with data from the test with Na-22 indicate an extra factor other than electromagnetic frequency, such as resonance or coherence, is at play to cause the unquantum effect. These extra factors are yet another discovery made using the method of Photon Violation Spectroscopy. Discoveries made with Photon Violation Spectroscopy reinforce the validity of Particle Violation Spectroscopy. In prior art light was thought to be a particle because the electron was thought to be a particle in the photoelectric effect. I show light is not a particle in the same class of test famous prior art has used in favor of light being a particle; therefore the electron is not a particle. Since electron and photon constructs fail to act like particles in a beam-split test, it follows that the theory of quantum mechanics represents nature falsely, my data and physics theory consistently represent nature truly, and the method of Particle Violation Spectroscopy is useful.

### CONCLUSIONS, RAMIFICATIONS, AND SCOPE

Actual experimental evidence and operation of the method of Particle Violation Spectroscopy have been described showing its distinction from methods of prior art. My experimental evidence utilizes what prior art would term particles with rest mass, and more particularly what prior art would term the alpha particle. In the nomenclature of Particle Violation Spectroscopy, the helium nucleus would be termed the helium nuclear matter wave. In my previous disclosure of Photon Violation Spectroscopy, the underlying mechanism implies electrons do not act like quantum mechanical particles. Therefore the electron should be able to split in a similar way to that performed here for the alpha ray. This could be accomplished by using a radioisotope that decays to emit a single electron. Beta decay would not be an appropriate source because the pulse amplitude is lowered by a distribution of neutrino energy shared in the process. On the other hand, when a gamma is emitted in spontaneous decay it will often generate an internal photoelectric conversion electron with its full kinetic energy preserved. A bare source of conversion electron events such as Cd-109 in a vacuum chamber may produce double high pulses in a single surface barrier detector. In other words, the physics behind the method predicts that two electrons can be loaded to threshold by one incident electron, to show itself in an anomalously high sum-peak.

It is obvious to apply the method of Particle Violation Spectroscopy to charge waves, neutron waves, proton waves, atomic waves, and to any particle-like micro-phenomenon that also displays wave properties. The object of the disclosure at hand is to provide evidence, methodology, and apparatus concerning the violation of quantum mechanics for rays associated with a rest mass, such as alpha rays and electronic rays. If a phenomenon displays diffraction, the phenomenon is not due to particles, and the probability interpretation can be shown to fail in a beam splitter test of the particle. I have provided evidence in this disclosure that my method provides ways to defy the principle of the particle and to gain useful information. A particle is something that holds itself together and should go one way or another at a beam splitter, unless it reacts and splits into sub-particles. My evidence for splitting the alpha could not be due to breaking an incident particle into sub-particles, because the binding energy of the incident ray and the target element exceeds the kinetic energy of the incident matter wave.

Spectroscopic and material science probe applications of my method in many forms are obvious. A tested commercially viable application for future manufacture is a miniature gold and diamond purity analyzer. It is obvious from my claims to apply Particle Violation Spectroscopy to more complicated sources of radiation that are known to coincidentally emit multiple quanta, by employing a third detector and appropriate electronics to certify a coincident pair, in addition to the usual two detectors claimed in Particle Violation Spectroscopy; this makes my method more useful. More elaborate schemes with arrays of detectors are obvious. It is also obvious from my claims to perform Particle Violation Spectroscopy with only one detector to measure sum-peaks occurring at rates surpassing chance calculation. Miniaturization and computer applications are obvious. The method of Particle Violation Spectroscopy, by measuring energy at such a fundamental level, will undoubtedly be further applied to material science, matter-energy conversion, and event control. My method measures a characteristic of the incident ray that is already present in the detector as the pre-loaded state. Such a new fundamental measurement will undoubtedly be useful in monitoring the flow of electric charge within a material under study in superconductivity research. The sensitivity of my method of measurement to crystalline silicon, and its ability to reveal crystalline states of matter implies that my method will undoubtedly find use in semiconductor applications such as developing solar cells.

I am often challenged on the issue of usefulness applied to a method or apparatus that displays a discovery in physics. Why would something as crude as gold leaf have the optics to split a matter wave of such short wavelength? The answer is that data from Particle Violation Spectroscopy relates to the workings of the microscopic world. These first successful tests with diamond and gold for measuring the matter wave pre-loaded state make the means of performing such a measure valuable in itself. My method reveals a fundamental discovery in physics that was not obvious at all. Any method revealing such a fundamental discovery in physics is useful. These first successful tests were successful in discriminating between different levels of gold purity and different crystalline states of carbon thereby making my method a useful tool in analysis of these materials. Such a unique test now available to be performed upon gold and diamonds makes those materials even more valuable. The relative ease of performing these comparative measurements upon other materials, other matter wave sources, and as part of another physical process, makes my method a widely applicable spectroscopy. A good example of a fundamental measurement in physics becoming even more useful is the invention of the measurement of nuclear magnetic resonance; this measurement has found great use in medical imaging. Expansion of my method to imaging applications is technically feasible. I have good photos and records of my work, and there have been no secrets. I'm selling my book.

New experiments are under construction in my laboratory extending my method to other physical variables besides chemical purity and structure. The method of Particle Violation Spectroscopy changes modern physics altogether; it is an entirely new and useful method of measuring the way matter can be divided. Methods of measuring physical properties are every bit as useful as methods of measuring chemical or biological properties. Indeed my new form of measurement introduces a new branch of physics. My claims are a direct confrontation to the formal scientific community: absorption is not quantized. My claims made upon the very method I have used to demonstrate a physics discovery of such importance, are useful in the practice of fundamental physics. I am not claiming a law of physics, but rather a method of performing measurements revealing a branch of physics. The following claims are made upon a broadly applicable, commercially viable, unique, tested and useful method of Particle Violation Spectroscopy.

I claim:

1. A method of characterizing matter rays and beam splitters in defiance of particle theory comprising the steps of:
(a) employing matter rays from a source unable to produce true coincidences in a two path characteristic pulse amplitude coincidence test with no beam splitter,
(b) employing a beam of matter rays from said source to be intercepted by a beam splitter material under measurement by deflecting said beam of matter rays into two paths to be intercepted by a pair of detectors,
(c) measuring with an electronics means pulses of amplitude characteristic of said source in coincidence, to deliver a beam split coincidence rate to be compared to a calculated chance coincidence rate determined with an electronics means utilizing singles rates of pulses characteristic of said source from each of said pair of detectors,
whereby the extent to which a ratio of said beam split coincidence rate divided by said calculated chance coincidence rate exceeds unity is a measure characterizing said beam splitter material under measurement.

2. The method of characterizing matter rays and beam splitters of claim 1 wherein said source is radioisotope americium 241 emitting alpha rays, and said beam splitter material under measurement is a thin foil of gold under measurement of its purity.

3. The method of characterizing matter rays and beam splitters of claim 1 wherein said source is radioisotope americium 241 emitting alpha rays, and said beam splitter material under measurement is a surface of carbon under measurement of its chemical structure.

4. The method of characterizing matter rays and beam splitters of claim 1 wherein said source is radioisotope americium 241 emitting alpha rays, and said beam splitter material under measurement is semiconductor grade silicon under measurement of its atomic properties.

5. A method of surpassing particle chance in measuring a beam splitter material requiring two tests that include a radioisotope source emitting a matter radiation of known chemical formula, a detector number 1 capable of delivering an electrical pulse number 1 with amplitude proportional to particle model kinetic energy of incident said matter radiation, an electronics means of filtering a preset range of said electrical pulse number 1 to set a window number 1 amplitude range characteristic of said matter radiation to deliver a timing pulse number 1, a detector number 2 capable of delivering an electrical pulse number 2 with amplitude proportional to particle model kinetic energy of incident said matter radiation, an electronics means of filtering a preset range of said electrical pulse number 2 to set a window number 2 amplitude range characteristic of said matter radiation to deliver a timing pulse number 2, an electronics means of delivering an experimental coincidence pulse when said timing pulse number 1 and said timing pulse number 2 are in coincidence within a preset time span, an electronics means of measuring an experimental coincidence rate from a plurality of said experimental coincidence pulse, and a means of calculating a calculated chance coincidence rate from rates of said timing pulse number 1 and said timing pulse number 2, the two tests comprising:
(a) testing said matter radiation in an arrangement with said detector number 1 and said detector number 2 to receive separate pathways of non overlapping solid angles of radiation from said radioisotope source to measure a control ratio of said experimental coincidence rate divided by said calculated chance coincidence rate, to insure said control ratio does not substantially exceed unity, signifying said radioisotope source emits one quantum of matter radiation at a time except by chance; and
(b) testing said matter radiation in an arrangement with said detector number 1 and said detector number 2 to receive overlapping solid angles of radiation from said radioisotope source by a beam splitter means made of said beam splitter material preceding said detector number 1 and said detector number 2 to obtain a test ratio of said experimental coincidence rate divided by said calculated chance coincidence rate, whereby when said test ratio substantially exceeds unity and having found from test (a) said radioisotope source emits one quantum of matter radiation at a time except by chance, the chance rate prediction of quantum mechanics is refuted and comparative repetition of the method with modification of test (b) may be performed for physical measurement of said beam splitter material.

6. The method of surpassing particle chance of claim 5 wherein said radioisotope source of said matter radiation of known chemical formula is americium 241, and said matter radiation is alpha rays.

7. The method of surpassing particle chance of claim 6 wherein said beam splitter means is a thin foil of gold under physical measurement of its purity.

8. The method of surpassing particle chance of claim 6 wherein said beam splitter means is a surface of carbon under physical measurement of its chemical structure.

9. The method of surpassing particle chance of claim 6 wherein said beam splitter means is semiconductor grade silicon under physical measurement of its atomic properties.

10. An apparatus for probing a beam splitter material to find characteristics related to fundamental principles of physics with said beam splitter material arranged in relation to a radioisotope source of matter waves to form a beam splitter means comprising:
(a) said radioisotope source of matter waves known to emit a single material quantum unable to create true coincidences upon spontaneous decay in a test without a beam splitter,
(b) a detector number 1 able to respond to said single material quantum from said radioisotope source by delivering an electrical pulse number 1,
(c) a detector number 2 able to respond to said single material quantum from said radioisotope source by delivering an electrical pulse number 2,
(d) a window means of eliminating pulse heights beyond a maximum and minimum range to obtain a desired characteristic pulse from a plurality of said electrical pulse number 1 to create a plurality of timing pulse number 1,
(e) a digital signal processor means of eliminating pulse heights beyond a maximum and minimum range to obtain a desired characteristic pulse from a plurality of said electrical pulse number 2 to create a plurality of timing pulse number 2,
(f) said beam splitter means of testing said radioisotope source with said detector number 1 and said detector number 2 arranged to receive overlapping solid angles of matter radiation from said radioisotope source,
(g) a computing number 1 means of measuring an experimental coincidence rate from said timing pulse number 1 and said timing pulse number 2 while utilizing said beam splitter means of step (f),
(h) a computing number 2 means of computing a chance coincidence rate computed from rates of said timing pulse number 1 and said timing pulse number 2,
(i) a ratio calculating means of determining a ratio of said experimental coincidence rate divided by said chance coincidence rate,
whereby the degree by which said ratio substantially exceeds unity serves as a quantitative comparative measure relating to fundamental principles of said beam splitter material.

11. The apparatus of claim 10 wherein said radioisotope source of matter waves is americium 241 emitting alpha rays, said beam splitter means is a thin foil placed to allow matter waves to transmit to said detector number 1 and reflect matter waves to said detector number 2.

12. The apparatus of claim 11 wherein said beam splitter material is a thin foil of gold under measure of its purity.

13. The apparatus of claim 11 wherein said beam splitter material is a surface of carbon under measure of its chemical structure.

14. The apparatus of claim 11 wherein said beam splitter material is semiconductor grade silicon under measure of its atomic alpha ray matter wave interaction.

15. A method of measuring material energy and fundamental material properties of a beam splitter, in violation of the principle of quantum mechanical absorption in a two path beam split test comprising:
(a) choosing as a source of radiation a radioisotope in spontaneous decay known to emit a single distinguishable characteristic material emitted quantum unable to create true coincidences from tests containing no beam splitter means;
(b) detecting said single distinguishable characteristic material quantum with a detector means of substantial pulse amplitude resolution and efficiency to produce a detection pulse;
(c) splitting said single distinguishable characteristic material quantum emitted from said source by a beam splitter means preceding two detectors of said detector means;
(d) producing a coincidence pulse by an electronics means from two of said detection pulse in coincidence;
(e) calculating an experimental coincidence rate by a computing means from a plurality of said coincidence pulse;
(f) calculating a chance coincidence rate that quantum mechanics would predict for said experimental coincidence rate by a computing means from a plurality of said detection pulse; and
(g) calculating a ratio of said experimental coincidence rate divided by said chance coincidence rate;
whereby when said ratio substantially exceeds unity, the principle of quantum mechanical absorption is violated, and said ratio becomes a quantitative comparative measure related to the fundamental material properties of said beam splitter and of said single distinguishable characteristic material emitted quantum from said radioisotope.

16. The method of measuring material energy and material properties of said beam splitter of claim 15 wherein said source of radiation is radioisotope americium 241 emitting alpha rays, and said beam splitter means is a is a thin foil of gold material under measurement of its purity.

17. The method of measuring material energy of claim 15 wherein said source of radiation is radioisotope americium 241 emitting alpha rays, and said beam splitter means is a is a surface of carbon material under measurement of its chemical structure.

18. The method of measuring material energy of claim 15 wherein said source of radiation is radioisotope americium 241 emitting alpha rays, and said beam splitter means is semiconductor grade silicon under measurement of its atomic alpha ray interaction.
